(19) United States
(12) Patent Application Publication
(10) Pub. No.: US 2025/0333854 A1
(43) Pub. Date: Oct. 30, 2025

(54) WATER ELECTROLYSIS SYSTEM

(71) Applicant: TOYOTA JIDOSHA KABUSHIKI KAISHA, Toyota-shi (JP)

(72) Inventor: Keiichi OKUBO, Susono-shi (JP)

(73) Assignee: TOYOTA JIDOSHA KABUSHIKI KAISHA, Toyota0shi (JP)

(21) Appl. No.: 19/011,986

(22) Filed: Jan. 7, 2025

(30) Foreign Application Priority Data
Apr. 26, 2024 (JP) 2024-072355

(51) Int. Cl. C25B 1/044; C25B 13/02; C25B 15/02

(52) U.S. Cl. CPC C25B 1/044; C25B 13/02; C25B 15/02

(57) ABSTRACT

A water electrolysis system that generates hydrogen and oxygen by electrolysis of water includes a water electrolysis cell including an anode, a cathode, and an electrolyte membrane sandwiched between the anode and the cathode, and a control device that controls electric power supplied to the water electrolysis cell, wherein the control device performs a potential changing process of changing a potential of the anode either or both of upon starting of the water electrolysis system and during continuous operation of the water electrolysis system, and the potential changing process includes a potential lowering process of lowering the potential of the anode to a predetermined potential.

### CROSS-REFERENCE TO RELATED APPLICATION

This application claims priority to Japanese Patent Application No. 2024-072355 filed on Apr. 26, 2024, incorporated herein by reference in its entirety.

### BACKGROUND

### 1. Technical Field

The present disclosure relates to water electrolysis systems.

### 2. Description of Related Art

A water electrolysis system is conventionally known that produces oxygen and hydrogen by performing electrolysis of water to generate oxygen at an anode and hydrogen at a cathode (Japanese Unexamined Patent Application Publication No. 2023-128165 (JP 2023-128165 A)). This water electrolysis system includes a water electrolysis stack composed of a plurality of cells. Each cell has a membrane electrode structure in which an ion-exchange membrane is sandwiched between an anode and a cathode. Each of the anode and the cathode includes a catalyst layer and a power feeder.

### SUMMARY

Upon starting of the water electrolysis system and during continuous operation of the water electrolysis system, the cells may be poisoned by water flowing in the water electrolysis system or impurities generated in the water electrolysis system, which may lower the catalytic activity or degrade the electrolyte membranes (ion-exchange membranes). The poisoned cells may result in a decrease in production amount and production efficiency of oxygen and hydrogen.

The present disclosure can be implemented in the following form.

(1) An aspect of the present disclosure provides a water electrolysis system. A water electrolysis system configured to produce hydrogen and oxygen by electrolysis of water includes:
a water electrolysis cell including an anode, a cathode, and an electrolyte membrane sandwiched between the anode and the cathode; and
a control device configured to control electric power to be supplied to the water electrolysis cell.

The control device is configured to perform a potential changing process either or both of upon starting of the water electrolysis system and during continuous operation of the water electrolysis system. The potential changing process is a process of changing a potential of the anode.

The potential changing process includes a potential lowering process of lowering the potential of the anode to a predetermined potential.

According to this aspect, the control device can restore electrolysis performance of the water electrolysis cell by performing the potential changing process either or both of upon starting of the water electrolysis system and during continuous operation of the water electrolysis system, namely either or both of the periods during which the water electrolysis cell may be poisoned. The above configuration can therefore reduce a decrease in production amount and production efficiency of oxygen and hydrogen in the water electrolysis system.

(2) In the above aspect,
the control device may be configured to perform the potential changing process once or more and 30 times or less.

According to this aspect, the control device can restore the electrolysis performance of the water electrolysis cell by performing the potential changing process once or more and 30 times or less.

(3) In the above aspect,
the control device may be configured to perform the potential lowering process by causing the hydrogen produced at the cathode to move from the cathode to the anode through the electrolyte membrane after stopping supply of the electric power to the water electrolysis cell.

According to this aspect, the control device can perform the potential lowering process by causing the hydrogen produced at the cathode to move from the cathode to the anode through the electrolyte membrane after stopping supply of the electric power to the water electrolysis cell.

(4) In the above aspect,
the control device may be configured to perform the potential changing process by controlling either or both of a current value and a voltage value that are used when supplying the electric power to the water electrolysis cell.

According to this aspect, the control device can perform the potential changing process by controlling either or both of the current value and the voltage value that are used when supplying the electric power to the water electrolysis cell.

(5) In the above aspect,
the electrolyte membrane may have a thickness of 25 μm or less.

According to this aspect, the control device can restore the electrolysis performance of the water electrolysis cell when the electrolyte membrane has a thickness of 25 μm or less.

The present disclosure can be implemented in various forms other than the above water electrolysis system. For example, the present disclosure can be implemented in forms such as a method for manufacturing a water electrolysis system, a water electrolysis method using a water electrolysis system, a method for controlling a water electrolysis system, a computer program that implements the method for controlling a water electrolysis system, and a non-transitory recording medium storing the computer program.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration of a water electrolysis system;

FIG. 2 is a schematic sectional view showing a configuration of a water electrolysis cell;

FIG. 3 is a diagram for explaining details of the potential changing process;

FIG. 4 is a table showing examination results of various conditions in the potential changing process;

FIG. 5 is a graph showing a change in current density for each number of times the potential changing process was performed; and

FIG. 6 is a graph showing the relationship between the thickness of the electrolyte membrane and the time required for the potential lowering process.

### DETAILED DESCRIPTION OF EMBODIMENTS

### A. First Embodiment

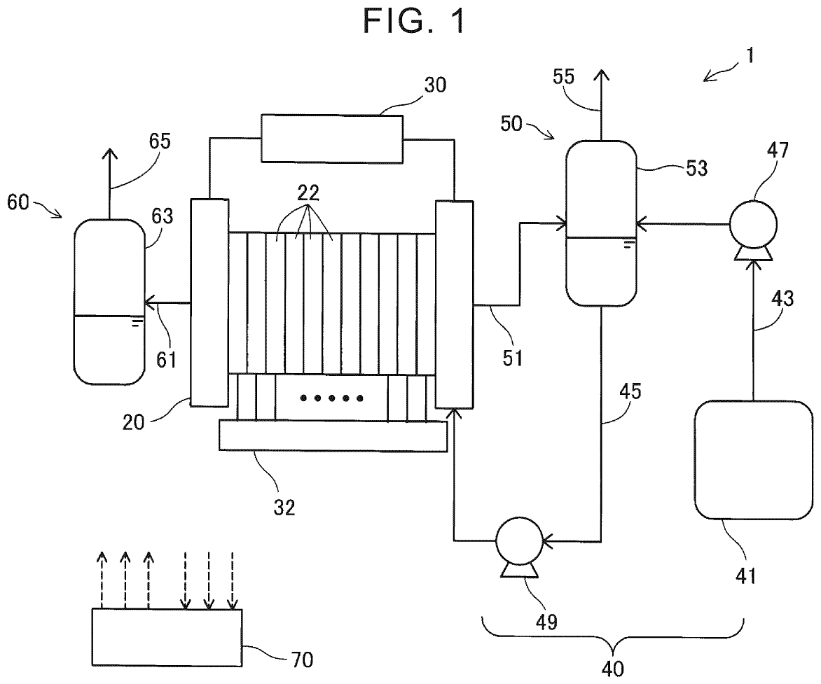

FIG. 1 is a diagram illustrating a configuration of a water electrolysis system 1. The water electrolysis system 1 generates hydrogen and oxygen by electrolysis of water. The water electrolysis system 1 includes a cell stack 20 in which a plurality of water electrolysis cells 22 are stacked, a power supply 30, a cell monitor 32, a water supply unit 40, an oxygen discharge unit 50, a hydrogen discharge unit 60, and a control device 70.

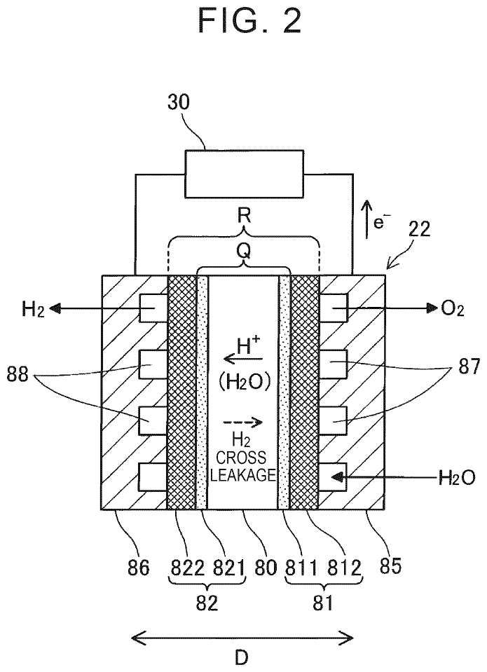

FIG. 2 is a schematic sectional view showing the configuration of the water electrolysis cell 22. The water electrolysis cell 22 includes an electrolyte membrane 80, an anode 81, a cathode 82, an anode-side separator 85, a cathode-side separator 86, an anode-side channel 87, and a cathode-side channel 88.

The electrolyte membrane 80 is sandwiched between the anode 81 and the cathode 82. The electrolyte membrane 80 is a membrane composed of a polymer having ion exchange groups. The electrolyte membrane 80 may have, for example, at least one of the following groups as the ion exchange group: a sulfonic acid group, a phosphoric acid group, and a quaternary ammonium group. The electrolyte membrane 80 may be an anion exchange membrane or a cation exchange membrane. The electrolyte membrane 80 may be, for example, a membrane composed of a perfluorocarbon sulfonic acid polymer, or a membrane composed of a polymer containing either polyether ether ketone or polybenzimidazole as a main component. Metals such as iridium, platinum, cerium, and manganese or their cations may be combined with the electrolyte membrane 80. When the metal is combined with the electrolyte membrane 80, the metal content contained in the electrolyte membrane 80 may be 5 μg/cm² or less, or may be 3 μg/cm² or less. The metal contained in the electrolyte membrane 80 may be a metal, an oxide, or an ion. In the present embodiment, the electrolyte membrane 80 is a proton (hydrogen ion) exchange membrane.

The anode 81 includes an anode catalyst layer 811 and an anode gas diffusion layer 812. The anode catalyst layer 811 is laminated on one surface of the electrolyte membrane 80. The anode gas diffusion layer 812 is laminated on the surface of the anode catalyst layer 811 opposite to the surface facing the electrolyte membrane 80 in the stacking direction D of the water electrolysis cells 22.

The anode catalyst layer 811 is a layer that functions as an anode electrode that generates oxygen. The anode catalyst layer 811 is formed, for example, by supporting an anode catalyst on a support by a binder.

The anode catalyst is metal particles that catalyze reactions that produce oxygen. The anode catalyst contains, for example, at least one of the following metals: platinum, ruthenium, iridium, rhodium, palladium, osmium, tungsten, lead, iron, chromium, cobalt, nickel, manganese, vanadium, molybdenum, gallium, aluminum, lanthanum, cerium, prascodymium, neodymium, samarium, gadolinium, and yttrium. The anode catalyst may contain two or more of the above metals. The anode catalyst preferably contains either iridium or ruthenium as a main component. The anode catalyst may be an oxide, a nitride, a sulfide, a phosphide, etc. The anode catalyst is preferably either an oxide or a nitride. The anode catalyst may be composed of at least one of the following types of particles: iridium particles, iridium alloy particles, and composite particles containing iridium. The iridium alloy particles and the composite particles containing iridium contain, for example, at least one of the following metals: ruthenium, rhodium, palladium, osmium, tungsten, lead, iron, chromium, cobalt, nickel, manganese, vanadium, molybdenum, gallium, aluminum, lanthanum, cerium, prascodymium, neodymium, samarium, gadolinium, and yttrium. The iridium alloy particles and the composite particles containing iridium may contain two or more of the above metals. The ratio of an element other than iridium in the iridium alloy particles is not particularly limited, and may be, for example, 0.11 atm % or more, and may be 60 atm % or less. The particle diameter of the metal particles constituting the anode catalyst is not particularly limited, and may be, for example, 1 nm or more and may be 5000 nm or less. In the present disclosure, the particle size of the metal particles is an average crystallite size measured by an X-ray diffraction method. In another embodiment, the particle diameter of the metal particles may be an average particle diameter calculated by measuring the particle diameters of a predetermined number of metal particles by an electron microscope and averaging the measured particle diameters of the metal particles. In order to calculate the average particle diameter, for example, the particle diameters of 100 or more and 1000 or less metal particles are measured by an electron microscope.

The anode catalyst may be supported on a support. The method of supporting the anode catalyst on the support is not particularly limited, and for example, a known method such as an impregnation support method can be employed. The support on which the anode catalyst is supported may be a primary particle or a secondary particle. The particle diameter of the primary particles constituting the carrier may be, for example, 5 nm or more and may be 5000 nm or less. The supported ratio of the anode catalyst supported on the support is not particularly limited, and may be, for example, 1% or more, 50% or more, or 100% or less. The support on which the anode catalyst is supported is composed of, for example, an oxide. The oxide of the support is, for example, at least one of the following oxides: titanium oxide, niobium oxide, tin oxide, tungsten oxide, and molybdenum oxide. The support on which the anode catalyst is supported may be composed of, for example, a mixture containing at least one of the above oxides.

The binder used when supporting the anode catalyst on the support is composed of, for example, either or both of a polymer and ionomer having an ion exchange group. The binder used when supporting the anode catalyst on the support may have, for example, at least one of the following groups as the ion exchange group: a sulfonic acid group, a phosphoric acid group, and a quaternary ammonium group. The binder used when supporting the anode catalyst on the support may be composed of an anion exchange polymer or a cation exchange polymer. The binder used when the anode catalyst is supported on the support may be composed of, for example, a perfluorocarbon sulfonic acid polymer. The binder may be composed of, for example, a polymer containing either polyether ether ketone or polybenzimidazole as a main component.

The anode gas diffusion layer 812 is a layer for distributing gas. The anode gas diffusion layer 812 is made of, for example, at least one of the following materials: carbon paper, carbon fibers, carbon cloth, a porous titanium material, and titanium fibers. The anode gas diffusion layer 812 may be composed of a combination of two or more of the above materials. The anode gas diffusion layer 812 may include a microporous layer composed of either or both of carbon and titanium particles.

The cathode 82 includes a cathode catalyst layer 821 and a cathode gas diffusion layer 822. The cathode catalyst layer 821 is laminated on the other surface of the electrolyte membrane 80. The cathode gas diffusion layer 822 is laminated on the surface of the cathode catalyst layer 821 opposite to the surface facing the electrolyte membrane 80 in the stacking direction D of the water electrolysis cells 22.

The cathode catalyst layer 821 is a layer that functions as a cathode electrode that generates hydrogen. The cathode catalyst layer 821 is formed by, for example, supporting a cathode catalyst on a support by a binder.

The cathode catalyst is metal particles that catalyze a reaction that produces hydrogen. The cathode catalyst contains, for example, at least one of the following metals: platinum, ruthenium, iridium, rhodium, palladium, osmium, tungsten, lead, iron, chromium, cobalt, nickel, manganese, vanadium, molybdenum, gallium, aluminum, lanthanum, cerium, prascodymium, neodymium, samarium, gadolinium, and yttrium. The cathode catalyst may contain two or more of the above metals. The cathode catalyst may be an oxide, a nitride, a sulfide, a phosphide, etc. The cathode catalyst may be composed of at least one of the following types of particles: platinum particles, platinum alloy particles, and composite particles containing platinum. The platinum alloy particles and the composite particles containing platinum contain, for example, at least one of the following metals as a metal other than platinum: ruthenium, iridium, rhodium, palladium, osmium, tungsten, lead, iron, chromium, cobalt, nickel, manganese, vanadium, molybdenum, gallium, aluminum, lanthanum, cerium, prascodymium, neodymium, samarium, gadolinium, and yttrium. The platinum alloy particles and the composite particles containing platinum may contain two or more of the above metals. The ratio of an element other than platinum in the platinum alloy particles is not particularly limited, and may be, for example, 0.11 atm % or more, and may be 60 atm % or less. The particle diameter of the metal particles of the cathode catalyst is not particularly limited, and may be, for example, 1 nm or more and may be 100 nm or less.

The cathode catalyst may be supported on a support. The method of supporting the cathode catalyst on the support is not particularly limited, and for example, a known method such as an impregnation support method can be employed. The support on which the cathode catalyst is supported may be a primary particle or a secondary particle. The particle diameter of the primary particles constituting the carrier may be, for example, 5 nm or more and may be 5000 nm or less. The supported ratio of the cathode catalyst supported on the support is not particularly limited, and may be, for example, 1% or more, 18% or more, 48% or less, or 70% or less. The support on which the cathode catalyst is supported is composed of, for example, at least one of the following: carbon that is electrically conductive, an oxide, and a mixture containing the carbon and the oxide. The carbon of the support is, for example, at least one of the following carbons: carbon black such as acetylene black, Ketjen black, and furnace black; activated carbon; graphite; glassy carbon; graphite; graphene; carbon fibers; carbon nanotubes; carbon nitride; carbon sulfide; carbon phosphide; channel black; roller black; disk black; oil furnace black; gas furnace black; lamp black; thermal black; and vulcanized carbon. The support on which the cathode catalyst is supported may be composed of a mixture containing at least one of the above carbons. The oxide of the support is at least one of the following oxides: titanium oxide, niobium oxide, tin oxide, tungsten oxide, and molybdenum oxide. The support on which the cathode catalyst is supported may be composed of, for example, a mixture containing at least one of the above oxides.

The binder used when supporting the cathode catalyst on the support is composed of, for example, either or both of a polymer or ionomer having an ion exchange group. The binder used when supporting the cathode catalyst on the support may have, for example, at least one of the following groups as the ion exchange group: a sulfonic acid group, a phosphoric acid group, and a quaternary ammonium group. The binder used when supporting the cathode catalyst on the support may be composed of an anion exchange polymer or a cation exchange polymer. The binder used when supporting the cathode catalyst on the support may be composed of, for example, a perfluorocarbon sulfonic acid polymer. The binder may be composed of, for example, a polymer containing either polyether ether ketone or polybenzimidazole as a main component.

The cathode gas diffusion layer 822 is a layer for distributing gas. The cathode gas diffusion layer 822 is made of, for example, at least one of the following materials: carbon paper, carbon fibers, carbon cloth, a porous titanium material, and titanium fibers. The cathode gas diffusion layer 822 may be composed of a combination of two or more of the above materials. The cathode gas diffusion layer 822 may include a microporous layer composed of either or both of carbon and titanium particles.

The two separators 85, 86 are disposed at both ends in the stacking direction D of the water electrolysis cell 22. The anode-side separator 85 faces the anode gas diffusion layer 812. The cathode-side separator 86 faces the cathode gas diffusion layer 822.

The anode-side channel 87 penetrates from the anode-side separator 85 to the anode 81 along the stacking direction D of the water electrolysis cell 22. The cathode-side channel 88 penetrates from the cathode-side separator 86 to the cathode 82 along the stacking direction D of the water electrolysis cell 22.

As shown in FIG. 1, the power supply 30 supplies electric power to the water electrolysis cell 22. The cell monitor 32 monitors the state of the water electrolysis cell 22.

As shown in FIGS. 1 and 2, the water supply unit 40 supplies water to the water electrolysis cell 22. In the present embodiment, the water supply unit 40 supplies water to the anode 81 of the water electrolysis cell 22. The water supply unit 40 includes a tank 41, a supply channel 43, a circulation channel 45, a supply pump 47, and a circulation pump 49. The tank 41 stores water to be supplied to the water electrolysis cell 22. The supply channel 43 connects the tank 41 and an anode-side gas-liquid separator 53 described later. The circulation channel 45 connects the anode-side gas-liquid separator 53 and the anode-side channel 87. The supply pump 47 is provided in the supply channel 43, and supplies water from the tank 41 to the anode-side gas-liquid separator 53. The circulation pump 49 is provided in the circulation channel 45, and supplies water from the anode-side gas-liquid separator 53 to the anode-side channel 87. In other embodiments, the water supply unit 40 may supply water to the cathode 82 instead of or in addition to the anode 81.

The oxygen discharge unit 50 includes an anode-side discharge path 51, an anode-side gas-liquid separator 53, and an oxygen discharge path 55. The anode-side discharge path 51 connects the anode-side gas-liquid separator 53 and the anode-side channel 87. The anode-side gas-liquid separator 53 separates the fluid discharged from the anode-side channel 87 into oxygen and water. The oxygen discharge path 55 discharges the oxygen separated in the anode-side gas-liquid separator 53 to the outside. The oxygen discharge path 55 is connected to, for example, a tank (not shown) that stores oxygen.

The hydrogen discharge unit 60 includes a cathode-side discharge path 61, a cathode-side gas-liquid separator 63, and a hydrogen discharge path 65. The cathode-side discharge path 61 connects the cathode-side gas-liquid separator 63 and the cathode-side channel 88. The cathode-side gas-liquid separator 63 separates the fluid discharged from the cathode-side channel 88 into hydrogen and water. The hydrogen discharge path 65 discharges the hydrogen separated in the cathode-side gas-liquid separator 63 to the outside. The hydrogen discharge path 65 is connected to, for example, a tank (not shown) that stores hydrogen.

During the period in which the electrolysis process for electrolyzing water is performed, water is supplied from the tank 41 to the anode 81, and electric power is supplied from the power supply 30 to the water electrolysis cell 22. As a result, the water supplied to the anode 81 is electrolyzed to generate hydrogen ions and oxygen. The oxygen generated at the anode 81 is sent to the anode-side gas-liquid separator 53 through the anode-side channel 87 and the anode-side discharge path 51 together with a portion of the remaining water without being electrolyzed. The oxygen separated in the anode-side gas-liquid separator 53 is discharged to the outside via the oxygen discharge path 55. The water separated in the anode-side gas-liquid separator 53 is supplied to the anode 81 again through the circulation channel 45 together with the water supplied from the tank 41. Hydrogen ions generated at the anode 81 pass through the electrolyte membrane 80 along with a portion of the remaining water without being electrolyzed and migrate to the cathode 82. At the cathode 82, hydrogen ions combine with electrons to produce hydrogen. The hydrogen generated in the cathode 82 passes through the electrolyte membrane 80 along with the hydrogen ions, and is sent to the cathode-side gas-liquid separator 63 through the cathode-side channel 88 and the cathode-side discharge path 61 together with the water that has migrated from the anode 81 to the cathode 82. The hydrogen separated in the cathode-side gas-liquid separator 63 is discharged to the outside via the hydrogen discharge path 65.

The control device 70 controls the water electrolysis system 1. During the period in which the electrolysis process is being performed, the control device 70 controls the operations of the supply pump 47 and the circulation pump 49. Thus, the control device 70 causes the anode 81 to supply water having a desired flow rate. In addition, the control device 70 sets the current value and the voltage value so that the anode 81 and the cathode 82 each have a predetermined electrolysis potential during the period in which the electrolysis process is performed, and operates the power supply 30. Thus, the control device 70 controls the electric power to be supplied to the water electrolysis cell 22. The electrolysis potential is an arbitrary potential. The electrolysis potential of the anode 81 is, for example, 1.5V or higher. The control device 70 performs the potential changing process at least once either or both of upon starting of the water electrolysis system 1 and during continuous operation of the water electrolysis system 1 in order to restore electrolysis performance of the water electrolysis cell 22.

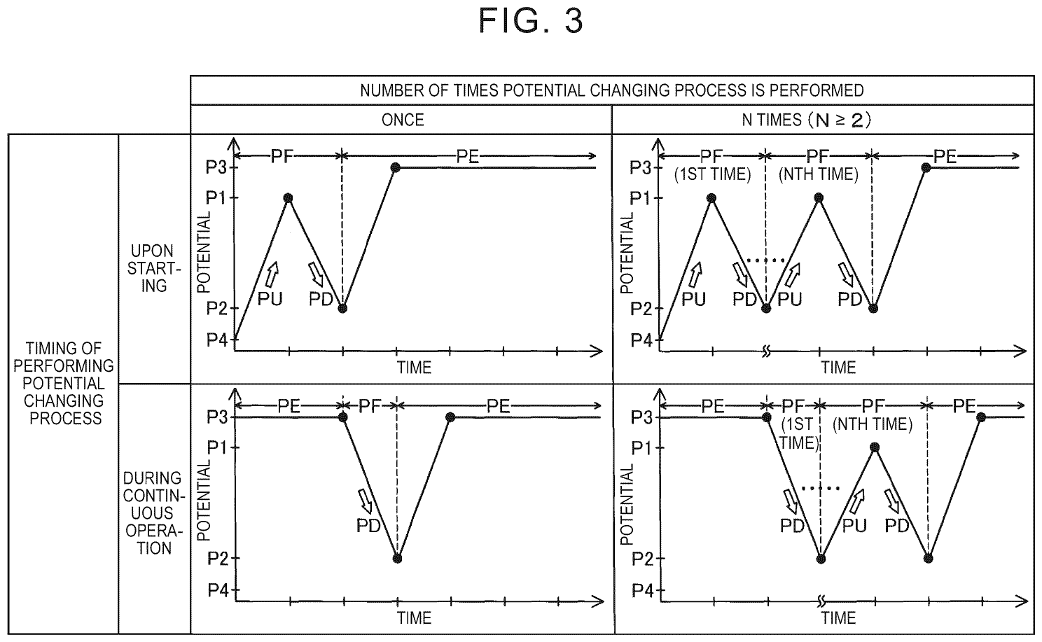

FIG. 3 is a diagram illustrating the potential changing process PF in detail. The vertical axis of each figure in FIG. 3 represents the potential of the anode 81. The horizontal axis of each figure in FIG. 3 represents time. The first potential P1 may be equal to the electrolysis potential P3, may be higher than the electrolysis potential P3, or may be lower than the electrolysis potential P3. The first potential P1 is preferably equal to or greater than 1.0 V (vs RHE), and more preferably equal to or greater than 1.4 V (vs RHE). The first potential P1 is preferably 3.0 V (vs RHE) or less, and more preferably 2.0 V (vs RHE) or less. The second potential P2 is lower than the first potential P1 and the electrolysis potential P3. The second potential P2 may be equal to the natural potential P4 and may be higher than the natural potential P4. The second potential P2 is preferably equal to or greater than −0.5 V (vs RHE), and more preferably equal to or greater than 0.0V (vs RHE). The second potential P2 is preferably 1.0 V (vs RHE) or less, 0.7 V (vs RHE) or less, and 0.2 V (vs RHE) or less.

The potential changing process PF is a process of changing the potential of the anode 81. The potential changing process PF includes a potential lowering process PD of lowering the potential of the anode 81 to a predetermined second potential P2. The potential changing process PF may further include a potential raising process PU that raises the potential of the anode 81 to a predetermined first potential P1.

Upon starting of the water electrolysis system 1, the control device 70 performs the potential changing process PF before starting the electrolysis process PE. Upon starting of the water electrolysis system I refers to when the power supply 30 is turned on and the control device 70 is started. Upon starting of the water electrolysis system 1, the potential of the anode 81 is a natural potential P4. Therefore, the control device 70 performs the following process when it performs the potential changing process PF once upon starting of the water electrolysis system 1. In this case, the control device 70 performs the potential raising process PU of raising the potential of the anode 81 from the natural potential P4 to the first potential P1 and the potential lowering process PD of lowering the potential of the anode 81 from the first potential P1 to the second potential P2 in this order. The control device 70 performs the following process when it performs the potential changing process PF N times (N is an integer of 2 or more) upon starting of the water electrolysis system 1. In this case, in the first potential changing process PF, the control device 70 performs the potential raising process PU of raising the potential of the anode 81 from the natural potential P4 to the first potential P1 and the potential lowering process PD of lowering the potential of the anode 81 from the first potential P1 to the second potential P2 in this order. In the second and subsequent potential changing processes PF, the control device 70 repeatedly performs the potential raising process PU for raising the potential of the anode 81 from the second potential P2 to the first potential P1 and the potential lowering process PD of lowering the potential of the anode 81 from the first potential P1 to the second potential P2 in this order N−1 times. After the potential changing process PF is completed, the control device 70 starts the electrolysis process PE by changing the potential of the anode 81 from the second potential P2 to the electrolysis potential P3.

During continuous operation of the water electrolysis system 1, the control device 70 performs the potential changing process PF before resuming the electrolysis process PE. During continuous operation of the water electrolysis system 1 refers to when the electrolysis process PE is being continuously performed for a predetermined time or more. The predetermined time is calculated in advance on the basis of, for example, a required time from the starting time of the electrolysis process PE to the time when the current density calculated using the data etc. output from the cell monitor 32 becomes less than a predetermined threshold. During continuous operation of the water electrolysis system 1, the potential of the anode 81 is the electrolysis potential P3. Therefore, when the potential changing process PF is performed once during continuous operation of the water electrolysis system 1, the control device 70 performs the following process. The control device 70 performs a potential lowering process PD of lowering the potential of the anode 81 from the electrolysis potential P3 to the second potential P2 without performing the potential raising process PU. When the potential changing process PF is performed N times during continuous operation of the water electrolysis system 1, the control device 70 performs the following process In this case, in the first potential changing process PF, the control device 70 performs a potential lowering process PD of lowering the potential of the anode 81 from the electrolysis potential P3 to the second potential P2 without performing the potential raising process PU. In the second and subsequent potential changing process PF, the control device 70 repeatedly performs the potential raising process PU for raising the potential of the anode 81 from the second potential P2 to the first potential P1 and the potential lowering process PD of lowering the potential of the anode 81 from the first potential P1 to the second potential P2 in this order N−1 times. After the potential changing process PF is completed, the control device 70 restarts the electrolysis process PE by changing the potential of the anode 81 from the second potential P2 to the electrolysis potential P3. After the potential changing process PF performed during continuous operation of the water electrolysis system 1 is completed, the control device 70 may stop the water electrolysis system 1 and terminate the electrolysis process PE.

As shown in FIG. 2, the control device 70, for example, stops the supply of electric power to the water electrolysis cell 22, and then moves the hydrogen generated in the cathode 82 from the cathode 82 to the anode 81 through the electrolyte membrane 80. As a result, the control device 70 performs the potential lowering process PD. That is, the control device 70 lowers the potential of the anode 81 to the second potential P2 by utilizing the hydrogen permeation property in which the hydrogen generated in the cathode 82 permeates through the electrolyte membrane 80 without supplying electric power from the power supply 30 to the water electrolysis cell 22. The hydrogen permeation characteristics of the electrolyte membrane 80 are also referred to as hydrogen cross leakage (crossover).

The control device 70 may control either or both of a current value and a voltage value that are used when supplying electric power to the water electrolysis cell 22, thereby supplying electric power from the power supply 30 to the water electrolysis cell 22 and performing the potential lowering process PD. When the potential lowering process PD is performed by controlling the current when the electric power is supplied to the water electrolysis cell 22, the control device 70 performs the following process. In this case, the control device 70 operates the power supply 30 by setting the potential of the anode 81 to a current value smaller than a current value set when the potential of the anode is set to either the first potential P1 or the electrolysis potential P3, for example. When the potential lowering process PD is performed by controlling the voltage when electric power is supplied to the water electrolysis cell 22, the control device 70 performs the following process. In this situation, the control device 70 operates the power supply 30 by setting the potential of the anode 81 to a voltage value smaller than a voltage value set when the potential of the anode is set to either the first potential P1 or the electrolysis potential P3, for example.

For example, the control device 70 controls either or both of a current value and a voltage value that are used when supplying electric power to the water electrolysis cell 22, thereby supplying electric power from the power supply 30 to the water electrolysis cell 22 to perform the potential raising process PU. When the potential raising process PU is performed by controlling the current when electric power is supplied to the water electrolysis cell 22, the control device 70 performs the following process. In this case, the control device 70 operates the power supply 30 by setting the potential of the anode 81 to a current value larger than the current value set when the potential of the anode is set to the second potential P2, for example. When the potential raising process PU is performed by controlling the voltage when electric power is supplied to the water electrolysis cell 22, the control device 70 performs the following process. In this case, the control device 70 operates the power supply 30 by setting the potential of the anode 81 to a voltage value larger than the voltage value set when the potential of the anode is set to the second potential P2, for example. Electric power is supplied from the power supply 30 to the water electrolysis cell 22 during the potential raising process PU. Therefore, during the period in which the potential raising process PU is performed, the amount of change in potential of the anode 81 caused by supplying electric power is larger than the amount of change in potential of the anode 81 caused by cross leakage of hydrogen. Therefore, a change in potential of the anode 81 due to the cross leakage of the hydrogen can be substantially ignored during the period in which the potential raising process PU is performed.

In the potential changing process PF, the potential of the anode 81 can be detected using, for example, either or both of a cell having a reference pole and a two-pole cell. When the potential of the anode 81 decreases due to the cross leakage of hydrogen, the potential difference between the anode 81 and the cathode 82 decreases. When the potential of the anode 81 increases due to supply of electric power, the potential difference between the anode 81 and the cathode 82 increases. The potential difference is equal to the voltage. Therefore, in the potential changing process PF, the control device 70 can confirm the progress of the potential changing process PF by confirming the transition of the voltage values of the plurality of water electrolysis cells 22 constituting the cell stack 20 using the output of the cell monitor 32.

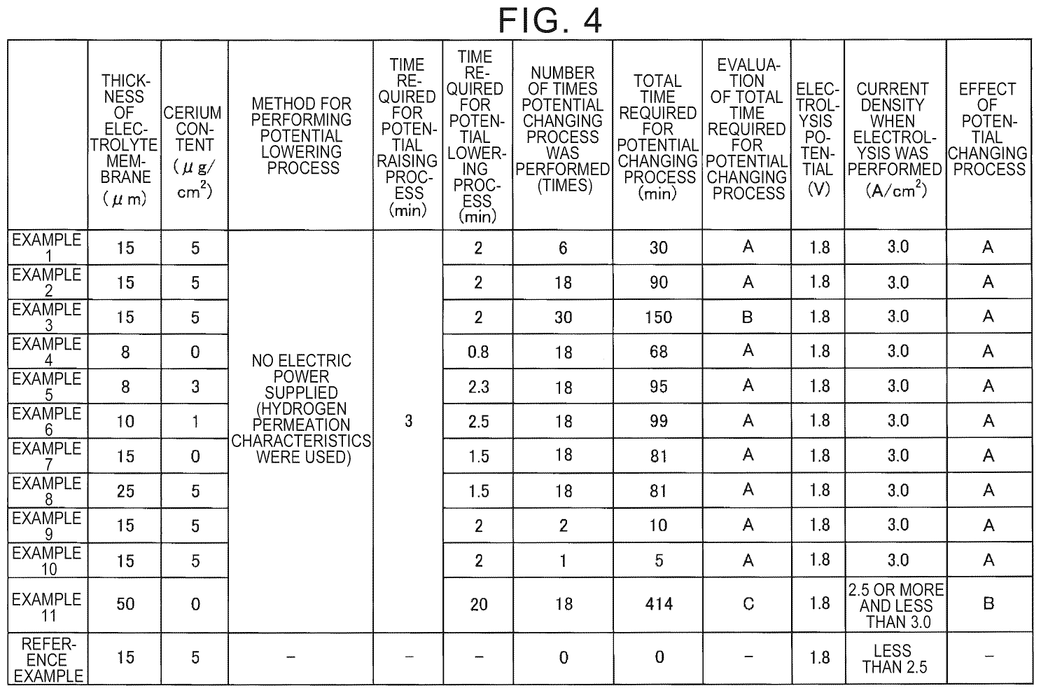

FIG. 4 is a chart showing the examination of various conditions in the potential changing process PF. FIG. 4 shows various conditions under which the potential changing process PF was performed different numbers of times upon starting of the water electrolysis system 1 on each of the plurality of water electrolysis cells 22 including the electrolyte membranes 80 having different thicknesses and cerium contents, and the evaluated results of the water electrolysis cells 22.

The water electrolysis cells 22 in Examples 1 to 11 and Reference Examples were prepared as follows. The anode catalyst layer 811 was prepared by dispersing, mixing, and coating the anode catalyst on a support. As the anode catalyst, Elyst Ir75 made by Umicore was used. The cathode catalyst layer 821 was prepared by dispersing, mixing, and coating the cathode catalyst on a support. As the cathode catalyst, platinum-supported carbon was used. The supported amount of platinum in the platinum-supported carbon used as the cathode catalyst was not less than 10 wt % and not more than 50 wt %. A perfluorocarbon sulfonic acid polymer based on Nafion (registered trademark) made by Chemours was used as the binder of each catalytic layer. The equivalent weight (EW) of the perfluorocarbon sulfonate polymer used as the binder was 1100. The electrolyte membrane 80 is sandwiched between the anode catalyst layer 811 and the cathode catalyst layer 821, and a pressure of 3 MPa is applied under a temperature condition of 145° C. to thermocompression bond the anode catalyst layer 811, the electrolyte membrane 80, and the cathode catalyst layer 821. As a result, the membrane electrode assembly Q was produced. Perfluorocarbon sulfonic acid polymers having different thicknesses and cerium contents were used as the electrolyte membranes 80. One anode gas diffusion layer 812 composed of a porous metal material is bonded to the anode 81 side of the membrane electrode assembly Q, and one cathode gas diffusion layer 822 composed of carbon fibers is bonded to the cathode 82 side of the membrane electrode assembly Q. As a result, the membrane electrode gas diffusion layer assembly R was produced. As the carbon fiber, GDL22BB made by SGL was used. The size of the produced membrane electrode gas diffusion layer assembly R was 1 cm². In the water electrolysis cell 22, an electrolyte membrane 80 of any material and composition, an anode catalyst layer 811, an anode gas diffusion layer 812, a cathode catalyst layer 821, and a cathode gas diffusion layer 822 can be used. The temperature and pressure at which the anode catalyst layer 811, the electrolyte membrane 80, and the cathode catalyst layer 821 are thermocompression bonded are not particularly limited, and an arbitrary temperature and pressure can be appropriately set.

Various conditions in the potential changing process PF were set as follows. The temperature of the water electrolysis cell 22 was set at 50° C. The second potential P2 was set to the natural potential P4 of the anode 81. The natural potential P4 of the anode 81 was less than or equal to 0.1V. The electrolysis potential P3 was set to 1.8V. The potential raising process PU was performed by controlling either or both of a current value and a voltage value that are used when supplying electric power to the water electrolysis cell 22. The duration of the potential raising process PU was set at 3 minutes. The potential lowering process PD was performed using the hydrogen permeability properties of the electrolyte membrane 80 without supplying electric power to the water electrolysis cell 22.

Various conditions in the potential changing process PF were evaluated as follows. The hydrogen permeable properties of the electrolyte membrane 80, the duration of the potential lowering process PD, and the current-voltage properties were evaluated with ultrapure water flowing through the anode 81. The total time required for the potential changing process PF was calculated by multiplying the sum of the time required for the potential raising process PU and the time required for the potential lowering process PD by the number of times the potential changing process PF was performed. The longer the total time required for the potential changing process PF, the later the timing at which the electrolysis process PE can be started. Therefore, it is preferable that the total duration required for the potential changing process PF be shorter within a range in which the electrolysis performance of the water electrolysis cell 22 can be restored. Therefore, the total time required for the potential changing process PF is “A” for a shorter time is the highest evaluation, and “C” for a longer time is the lowest evaluation.

The water electrolysis cell 22 was evaluated as follows. The performance of the water electrolysis cell 22 was evaluated under atmospheric pressure without applying gas pressure to both the anode 81 and the cathode 82. In Examples 1 to 11, the water electrolysis cell 22 was evaluated by the current density obtained when the electrolysis process PE was performed with the electrolysis potential P3 controlled to 1.8V after the potential changing process PF ended. In the reference example, the water electrolysis cell 22 was evaluated by the current density obtained when the electrolysis process PE was performed with the electrolysis potential P3 controlled to 1.8V without performing the potential changing process PF after starting of the water electrolysis system 1. The higher the electrolysis performance of the water electrolysis cell 22, the higher the current density when the electrolysis process PE is performed. The lower the electrolysis performance of the water electrolysis cell 22, the lower the current density when the electrolysis process PE is performed. Therefore, in the potential changing process PF, “A” having a larger current density when the electrolysis process PE is performed is the highest evaluation, and “C” having a smaller current density when the electrolysis process PE is performed is the lowest evaluation. In the water electrolysis cells 22 of Examples 1 to 11 in which the electrolysis process PE was performed after the potential changing process PF was performed, when the electrolysis process PE was performed while the electrolysis potential P3 was controlled to be 1.8V, the maximal saturation current density was 3.0 A/cm². In the water electrolysis cell 22 of the reference embodiment in which the electrolysis process PE was performed without performing the potential changing process PF, the current density when the electrolysis process PE was performed while the electrolysis potential P3 was controlled to be 1.8V was less than 2.5 A/cm². Therefore, the effectiveness of the potential changing process PF was evaluated on the basis of the saturated current density. When the current supplied to the water electrolysis cell 22 is controlled in the electrolysis process PE, the water electrolysis cell 22 may be evaluated using, for example, a saturated voltage when the electrolysis process PE is performed.

In Examples 1 to 11 in which the electrolysis process PE is performed after the potential changing process PF is performed, the current density when the electrolysis process PE is performed is larger than that in the reference example in which the electrolysis process PE is performed without performing the potential changing process PF. Therefore, the control device 70 can restore the electrolysis performance of the water electrolysis cell 22 by performing the potential changing process PF at least once.

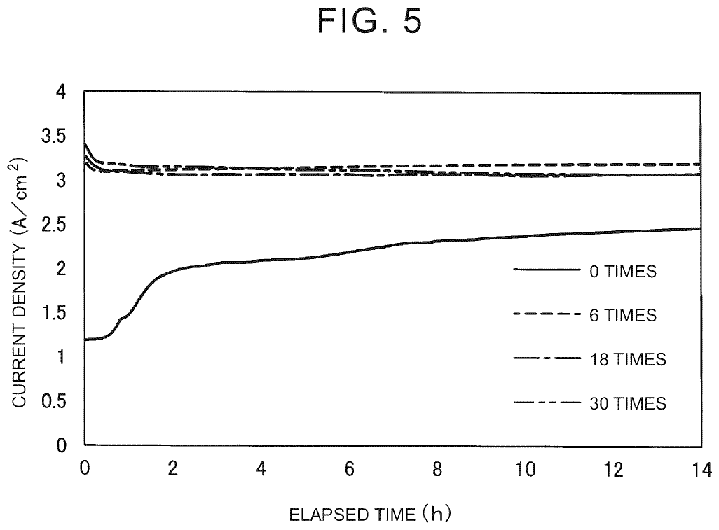

FIG. 5 is a graph showing a change in current density for each number of times the potential changing process PF was performed. The vertical axis of FIG. 5 represents the current density when the electrolysis process PE is performed while the electrolysis potential P3 is controlled to be 1.8V. The horizontal axis in FIG. 5 represents the elapsed time from the time when the electrolysis process PE is started. The current density when the electrolysis process PE was performed is the same when the potential changing process PF was performed six times, 18 times, and 30 times. As shown in Examples 1 to 3, 9, and 10 of FIG. 4, the current density when the electrolysis process PE was performed is the same when the potential changing process PF was performed once, twice, six times, 18 times, and 30 times. Therefore, the control device 70 performs the potential changing process PF once or more and 30 times or less, for example. Here, it is preferable that the total time required for the potential changing process PF be shorter as long as the equivalent effect of recovering the electrolysis performance of the water electrolysis cell 22 can be obtained. As shown in Examples 1 to 3 of FIG. 4, with the same thickness of the electrolyte membrane 80 and the same cerium content, the smaller the number of times the potential changing process PF is performed, the shorter the total time required for the potential changing process PF is. Therefore, the control device 70 preferably performs the potential changing process PF 1 time or more and 18 times or less, more preferably 1 time or more and 6 times or less. The number of times the potential changing process PF is performed is not limited to the above. The control device 70 may perform the potential changing process PF 31 times or more.

As shown in Examples 1 to 3 in FIG. 4, the total time required for the potential changing process PF is 30 minutes, 90 minutes, and 150 minutes, the current density when performing the electrolysis process PE is equivalent. Therefore, the control device 70 performs the potential changing process PF, for example, so that the sum of the potential changing process PF is less than or equal to 150 minutes. Here, it is preferable that the total time required for the potential changing process PF be shorter as long as the equivalent effect of recovering the electrolysis performance of the water electrolysis cell 22 can be obtained. Therefore, the control device 70 preferably performs the potential changing process PF so that the total time of the potential changing process PF is within 90 minutes, and more preferably performs the potential changing process PF so that the total time of the potential changing process PF is within 30 minutes.

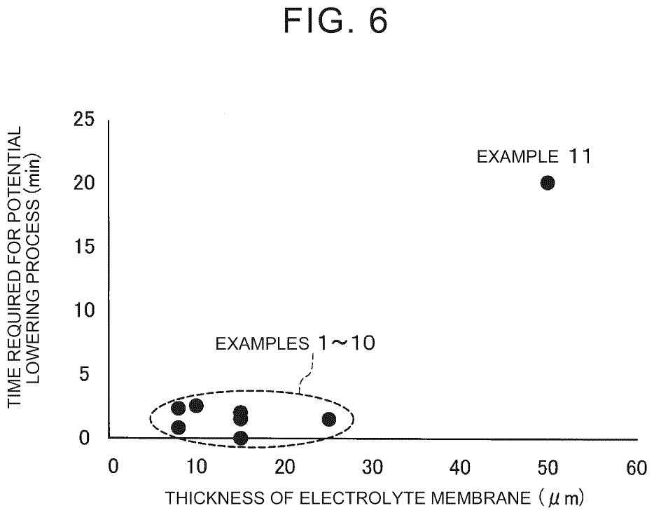

FIG. 6 is a diagram showing the relation between the thickness of the electrolyte membrane 80 and the required duration of the potential lowering process PD. The larger the thickness of the electrolyte membrane 80, the more difficult the hydrogen generated in the cathode 82 is to permeate through the electrolyte membrane 80, and the smaller the amount of hydrogen transferred from the cathode 82 to the anode 81 per unit time may be. The lower the transfer rate of hydrogen from the cathode 82 to the anode 81 per unit time, the longer the required time of the potential lowering process PD. In practice, in Example 11 in which the thickness of the electrolyte membrane 80 is 50 μm, the required duration of the potential lowering process PD is longer than in Examples 1 to 10 in which the thickness of the electrolyte membrane 80 is 25 μm or less. The longer the required time of the potential lowering process PD, the longer the total time required for the potential changing process PF. Further, as shown in FIG. 4, in Example 11 in which the thickness of the electrolyte membrane 80 is 50 μm, the current density when the electrolysis process PE is performed is smaller than in Examples 1 to 10 in which the thickness of the electrolyte membrane 80 is 25 μm or less. Therefore, when the control device 70 performs the potential lowering process PD using the hydrogen permeable property of the electrolyte membrane 80, the thickness of the electrolyte membrane 80 is preferably 25 μm or less. Here, in Example 2 in which the thickness of the electrolyte membrane 80 is 15 μm, and in Example 8 in which the thickness of the electrolyte membrane 80 is 25 μm, the current density when the electrolysis process PE is performed is the same, and it is possible to obtain the equivalent effect of recovering the electrolysis performance of the water electrolysis cell 22. Therefore, when the control device 70 performs the potential lowering process PD using the hydrogen permeable property of the electrolyte membrane 80, the thickness of the electrolyte membrane 80 is more preferably 15 μm or less. In Example 4 in which the thickness of the electrolyte membrane 80 is 8 μm, the required duration of the potential lowering process PD is shorter than in Example 1 in which the thickness of the electrolyte membrane 80 is 15 μm. The shorter the required time of the potential lowering process PD, the shorter the total time required for the potential changing process PF. Therefore, when the control device 70 performs the potential lowering process PD using the hydrogen permeable property of the electrolyte membrane 80, the thickness of the electrolyte membrane 80 is more preferably 8 μm or less. The thickness of the electrolyte membrane 80 is not limited to the above. The thickness of the electrolyte membrane 80 may be greater than 25 μm or greater than 50 μm. The thickness of the electrolyte membrane 80 can be measured by, for example, either or both of SEM (Scanning Electron Microscope) measurement and microscope measurement.

By combining cerium with the electrolyte membrane 80, the durability of the electrolyte membrane 80 can be improved. However, since cerium is a cation, the higher the cerium content of the electrolyte membrane 80, the harder the hydrogen generated in the cathode 82 permeates through the electrolyte membrane 80. Therefore, the amount of hydrogen transferred from the cathode 82 to the anode 81 per unit time may be reduced. In fact, in Example 2 in which the cerium content of the electrolyte membrane 80 is 5 μg/cm², the duration of the potential lowering process PD is longer than in Example 7 in which the cerium content of the electrolyte membrane 80 is 0 μg/cm². In Example 5 in which the cerium content of the electrolyte membrane 80 is 3 μg/cm², the duration of the potential lowering process PD is longer than in Example 4 in which the cerium content of the electrolyte membrane 80 is 0 μg/cm². In Examples 4 and 5 in which the thickness of the electrolyte membrane 80 is 8 μm, as compared with Examples 2 and 7 in which the thickness of the electrolyte membrane 80 is 15 μm, the required duration of the potential lowering process PD due to the presence of cerium in the electrolyte membrane 80 is increased. Therefore, the cerium content of the electrolyte membrane 80 may be determined in accordance with the thickness of the electrolyte membrane 80 so that the required time of the potential lowering process PD is less than or equal to a desired time. The cerium content of the electrolyte membrane 80 is not limited to the above. The cerium content of the electrolyte membrane 80 may be greater than 5 μg/cm². The contents of cerium, platinum, manganese, etc. in the electrolyte membrane 80 can be detected by, for example, ICP (Inductively Coupled Plasma) measurement.

According to the above embodiment, the control device 70 can restore electrolysis performance of the water electrolysis cell 22 by performing the potential changing process PF either or both of upon starting of the water electrolysis system 1 and during continuous operation of the water electrolysis system 1, namely either or both of the periods during which the water electrolysis cell 22 may be poisoned. Thus, in the water electrolysis system 1, it is possible to suppress a decrease in the generation amount and the generation efficiency of oxygen and hydrogen.

In addition, according to the above embodiment, the control device 70 can restore the electrolysis performance of the water electrolysis cell 22 by performing the potential changing process PF once or more and 30 times or less. Furthermore, the control device 70 can restore the electrolysis performance of the water electrolysis cell 22 by performing the potential changing process PF once or more and 18 times or less. In this way, the control device 70 can recover the electrolysis performance of the water electrolysis cell 22 in a shorter time. Furthermore, the control device 70 can restore the electrolysis performance of the water electrolysis cell 22 by performing the potential changing process PF once or more and six times or less. In this way, the control device 70 can recover the electrolysis performance of the water electrolysis cell 22 in a shorter time.

According to the above embodiment, the control device 70 can restore the electrolysis performance of the water electrolysis cell 22 by performing the potential changing process PF so that the total time of the potential changing process PF is 150 minutes or less. Furthermore, the control device 70 can restore the electrolysis performance of the water electrolysis cell 22 by performing the potential changing process PF so that the total time of the potential changing process PF is less than or equal to 90 minutes. In this way, the control device 70 can recover the electrolysis performance of the water electrolysis cell 22 in a shorter time. Furthermore, the control device 70 can restore the electrolysis performance of the water electrolysis cell 22 by performing the potential changing process PF so that the total time of the potential changing process PF is less than or equal to 30 minutes. In this way, the control device 70 can recover the electrolysis performance of the water electrolysis cell 22 in a shorter time.

Further, according to the above embodiment, after stopping supply of electric power to the water electrolysis cell 22, the control device 70 causes the hydrogen generated in the cathode 82 to pass through the electrolyte membrane 80 and move from the cathode 82 to the anode 81. The control device 70 can thus perform the potential lowering process PD. At this time, the thickness of the electrolyte membrane 80 constituting the water electrolysis cell 22 may be 25 μm or less. In this way, the control device 70 can recover the electrolysis performance of the water electrolysis cell 22 in a shorter time.

According to the above embodiment, the control device 70 can perform the potential changing process PF by controlling either or both of the current value and the voltage value that are used when supplying electric power to the water electrolysis cell 22.

### B. Other Embodiments

The potential changing process PF may further include a first holding process of holding the potential of the anode 81 at the first potential P1 in a predetermined time interval after the potential raising process PU. The potential changing process PF may further include a second holding process of holding the potential of the anode 81 at the second potential P2 in a predetermined time interval after the potential lowering process PD.

The present disclosure is not limited to the embodiments above, and can be implemented with various configurations without departing from the scope of the present disclosure. For example, the technical features of the embodiments corresponding to the technical features in each mode described in the section of the summary of the disclosure may be replaced or combined appropriately to solve part or all of the above issues or to achieve part or all of the above effects. When the technical features are not described as essential in this specification, the technical features can be deleted as appropriate.

What is claimed is:

1. A water electrolysis system configured to produce hydrogen and oxygen by electrolysis of water, the water electrolysis system comprising:
a water electrolysis cell including an anode, a cathode, and an electrolyte membrane sandwiched between the anode and the cathode; and
a control device configured to control electric power to be supplied to the water electrolysis cell, wherein:
the control device is configured to perform a potential changing process either or both of upon starting of the water electrolysis system and during continuous operation of the water electrolysis system, the potential changing process being a process of changing a potential of the anode; and
the potential changing process includes a potential lowering process of lowering the potential of the anode to a predetermined potential.

2. The water electrolysis system according to claim 1, wherein the control device is configured to perform the potential changing process once or more and 30 times or less.

3. The water electrolysis system according to claim 1, wherein the control device is configured to perform the potential lowering process by causing the hydrogen produced at the cathode to move from the cathode to the anode through the electrolyte membrane after stopping supply of the electric power to the water electrolysis cell.

4. The water electrolysis system according to claim 1, wherein the control device is configured to perform the potential changing process by controlling either or both of a current value and a voltage value that are used when supplying the electric power to the water electrolysis cell.

5. The water electrolysis system according to claim 1, wherein the electrolyte membrane has a thickness of 25 μm or less.
